(19) United States
(12) Patent Application Publication
(10) Pub. No.: US 2022/0409937 A1
(43) Pub. Date: Dec. 29, 2022

(54) FLAME ARRESTOR

(71) Applicant: Essex Industries, Inc., St. Louis, MO (US)

(72) Inventors: William C. Dean, Valley Park, MO (US); Michael Maragni, Manchester, MO (US)

(21) Appl. No.: 17/358,890

(22) Filed: Jun. 25, 2021

(51) Int. Cl. A62C 4/00; A62C 3/08

(52) U.S. Cl. CPC A62C 4/00; A62C 3/08

(57) ABSTRACT

A flame arrestor which will generally comprise two hollow sections, each of which includes a plurality of hollow channels, and with a throat between them which is open. This open portion can be used to induce turbulent flow into fluid which is has a laminar flow through the channels.

### BACKGROUND OF THE INVENTION

### Field of the Invention

This invention relates to a flame arrestor for inhibiting deflagration from one area to another, particularly to a flame arrestor useful in an aircraft fuel tank vent or hydraulic system.

### Description of the Related Art

Powered flight can easily be considered one of humankind's greatest accomplishments. The modern aircraft is an amazing piece of engineering and the skill requirements to keep it aloft are also impressive. Everything about an aircraft is quite a bit different from that of a ground-based vehicle. The reason is immediately apparent. An aircraft operates in a three-dimensional space and is not supported by any solid surface. A ground-based vehicle typically only operates in a two-dimensional space as it needs to remain in contact with the ground during primary operation.

Operation hi three-dimensional space presents aircraft with a number of concerns that ground-based vehicles simply do not have. In the first instance, safety is a major concern as humans, whether as operators or passengers in an aircraft, are not native to the skies. Aircraft have to deal with the fact that they are operating in an environment which typically does not allow for a safe stop to disembark human passengers or crew. A ground-based vehicle can typically be simply stopped if there are concerns in its operation, passengers and operators can disembark, and the vehicle can be safely inspected and repaired. Thus, in most cases, ground-based vehicles' major concern with failure of operation is safely coming to a stop and not in being able to get where they are going.

In an aircraft, there is typically no way to safely stop in midair. Instead, should an aircraft discover a midair concern, the aircraft still needs to have a place to land and safe landing typically requires sufficient aircraft operability, and sufficient landing space, for the aircraft to return to earth in a controlled fashion without hitting anything. An aircraft in midair is effectively only safe so long as it continues to operate correctly. This is mostly due to the pull of gravity on the aircraft trying to take it from the sky, as opposed to a ground-based vehicle where gravity typically assists in keeping it safely on the ground.

Because of the nature of their operation, one of the major concerns aboard aircraft is fire. While fire is dangerous anywhere, fire on an aircraft presents a number of new concerns. In the first instance, those onboard aircraft are typically confined to the aircraft and are reliant on the aircraft for breathable air. Thus, they cannot evacuate an airborne aircraft to avoid a spreading fire. Further, at flying altitude, there is often insufficient oxygen in the atmosphere to allow humans to safely breathe. Thus, oxygen supplies are typically carried or generated on-board an aircraft. However, as oxygen is a component of combustion, should fire break out within a passenger compartment of an aircraft, the breathable supply of oxygen can be rapidly consumed. Further, the consumption of such oxygen tends to place flame in close contact with human passengers.

A second problem with fire on-board an aircraft is that fire will typically serve to continually damage the structure of an aircraft and such continued damage will, over time, result in the flight characteristics of the aircraft being degraded as materials which are necessary to steer the aircraft, and/or to keep it aloft, become increasingly damaged. Thus, fires on-board aircraft need to be quickly extinguished, or at least contained to parts of the aircraft where damage can be confined and which will not serve to degrade flight performance. Aircraft operators are typically unable to reach a fire which is not in the passenger compartment and, thus, extinguishing a fire during flight can be exceedingly difficult. So long as the flight capability of the aircraft is maintained, the aircraft can be landed in a controlled fashion and passengers can be separated from the aircraft before the flame damages areas that are necessary for flight or life support.

Even with all these concerns of fire in flight, fire is a necessary part of flight. The vast majority of aircraft are reliant on combustion to provide the power for their engines either indirectly, by combustion being used to turn motors which in-turn rotate propellers or rotors, or directly through the pressurized exhaust of combustion materials providing the thrust to propel a jet aircraft through the air. Thus, all aircraft tend to carry, and directly combust, highly flammable materials during the course of flight. Typical commercial aircraft at takeoff will usually have 25-50% of their total weight be in liquid fuel which will be combusted during flight.

This large amount of fuel in an aircraft not only creates a concern in flight, but a concern on the ground. When ready for takeoff, a commercial aircraft is extremely flammable and usually loaded with people. Further, the people are sealed into the aircraft in order to provide for the pressurization of the cabin necessary for comfortable flight and for a breathable atmosphere on board. Airports themselves are also laden with fuel. The need to fuel multiple large aircraft at an airport requires vast amounts of fuel storage as well as fuel trucks or other delivery systems to get the fuel to the aircraft. Further, in most cases, the tarmac of an airport will commonly have fuel on it due to spills. Should a fire occur at the airport nearby an aircraft, should an aircraft be struck by lightning, or if an aircraft is otherwise near a possible ignition event, an aircraft can easily catch on fire on the ground.

One of the primary risk points for fire entering into an aircraft fuel system is the fuel tank vent. The fuel vent is necessary to control pressure within the fuel tank. Without a vent, it would be impossible to add fuel to a tank (as no air could escape) or to remove fuel from the tank (as the tank would build a powerful vacuum inhibiting fuel flow). Further, fuel is known to change in volume and/or pressure because of temperature changes and these changes in volume and/or pressure also have to be accommodated by the tank. Thus, aircraft (and in fact all) fuel tanks include some form of a vent which allows the tank and other components of the fuel system to vent to the atmosphere. However, by having an opening to the atmosphere, these vents also provide a point through which a nearby flame can deflagrate and enter the fuel system and fuel tank, which is potentially catastrophic.

In addition to ground fire events such as those contemplated above, an aircraft that engages in an emergency landing or crashes is also subject to a fire hazard. An aircraft crash can result in major fuel spills and danger as fuel may leave the aircraft and catch fire in the area that the aircraft now rests. Particularly in a crash situation, if a fire can spread to the aircraft, it can inhibit passengers from disembarking safely.

The primary danger of fire to aircraft on the ground is not the aircraft being damaged by the fire, but the aircraft catching on fire too quickly and too fiercely for it to be evacuated. Because of the necessary design of passenger aircraft to be flightworthy, they are somewhat difficult to evacuate. Passengers have to disembark via small doors which are long way from the ground. While escape slides and other measures are well-known and well-utilized, disembarking from an aircraft takes time and if the aircraft still has substantial fuel in its tanks and fire can get into those tanks, the aircraft will typically be quickly engulfed in flame and those still onboard will be unable to evacuate. For this reason, there are typically regulations on how long an aircraft fuel system needs to be able to resist deflagration from an outside flame to give passengers time to evacuate.

Outside of fuel, other materials used on board aircraft are also often highly combustible. Fluids used in hydraulics as well as lubricants often will readily burn as a byproduct of being able for them to accurately provide their desired function. These types of flammable fluids are typically concentrated in fuel supply systems and engines, which serve to transport the large amounts of fuel necessary to run modem aircraft engines and the engines themselves.

To deal with the potential risk of fire or explosion in aircraft engines a number of safety measures exist. For example, aircraft engines typically include systems that automatically detect increases in heat where such increase is unexpected and indicative of fire. The engine then typically includes a fire extinguishing system. When a fire is detected, the pilot will prohibit additional flammable material (fuel, hydraulic fluid, etc.) from entering the engine, shut down the engine (which will extinguish fires in some locations directly), and flood other portions of the engine with an inert gas or firefighting agent from an automatic firefighting system built into or near the engine.

While these systems are highly effective, there are areas within an engine and fuel system that can present additional problems. One of these relates to the engine's hydraulics. Hydraulic systems are prone to leakage. Typically, even the best hydraulic systems, over time, will develop small leaks as seals wear or degrade. While small leaks are to be expected, knowledge that they are occurring, and the amount of material which is leaking, is highly important. Knowledge of the amount of leakage allows maintenance personnel to make sure that there are always sufficient amounts to prevent a catastrophic failure. Further, monitoring of leaking can provide indications of when maintenance has become necessary to prevent catastrophic failure.

One of the ways that hydraulic leaks in various pumps are monitored is through the use of a small storage bottle. The bottle is attached to the pump and will collect any hydraulic fluid that has leaked out. This bottle can then be viewed to determine how much fluid has leaked and make sure that the leak is not outside safe operating parameters. However, these bottles can also present a fire hazard should flame be able to enter them such as through a nearby fire event, a lightning strike, or something similar.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a flame arrestor which can be positioned in a variety of locations where fluid flow is required through the flame arrestor, but deflagration through the flame arrestor needs to be prohibited. Embodiments of a flame arrestor which will generally comprise two hollow sections, each of which includes a plurality of hollow channels, and with a throat between them which is open will be discussed herein. This open portion can be used to induce turbulent flow into fluid which is has a laminar flow through the channels.

There is described herein, among other things, a flame arrestor comprising: a main body including a hollow core therethrough, the core having a wide section, a narrow section, and a throat interconnecting the wide section and the narrow section; a wide honeycomb comprising a first series of hollow channels positioned in the wide section of the main body; and a narrow honeycomb comprising a second series of hollow channels positioned in the narrow section of the main body; wherein at least a portion of the core at the throat does not include any of the hollow channels passing therethrough.

In an embodiment of the arrestor, the first series of hollow channels includes more channels than the second series of hollow channels.

In an embodiment of the arrestor, the cross-sectional area of a channel in the first series of channels is generally equal to the cross-sectional area of a channel in the second series of channels.

In an embodiment of the arrestor, the throat smoothly transitions the wide section into the narrow section.

In an embodiment of the arrestor, the main body comprises: a thread portion including external threads; a center portion; and a neck portion.

In an embodiment of the arrestor, the wide section extends through the thread portion and into the center portion.

In an embodiment of the arrestor, the narrow section extends through the neck portion.

In an embodiment of the arrestor, the throat is at least partially within the center portion.

In an embodiment of the arrestor, the throat is at least partially within the neck portion.

In an embodiment of the arrestor, the thread portion has a larger cross-sectional area than the neck portion.

In an embodiment of the arrestor, the center portion has a larger cross-sectional area than the thread portion.

In an embodiment of the arrestor, the external threads are sized and shaped to connect to a fuel tank vent of an aircraft.

In an embodiment of the arrestor, the external threads are sized and shaped to connect to a hydraulic system of an aircraft.

In an embodiment of the arrestor, at least a portion of the narrow section does not include any of the hollow channels passing therethrough.

In an embodiment of the arrestor, at least a portion of the wide section does not include any of the hollow channels passing therethrough.

### BRIEF DESCRIPTION OF THE DRAWINGS

FIG. 1 provides a perspective view of an embodiment of a flame arrestor.

FIG. 2 provides a cut-through of the embodiment of FIG. 1.

### DETAILED DESCRIPTION OF THE PREFERRED EMBODIMENT(S)

The embodiment of a flame arrestor (100) discussed herein is suitable for any type of installation where fluid (either gas or liquid) needs to be able to pass through the flame arrestor (100), but flame needs to be inhibited and/or prevented from passing through the flame arrestor (100). In many cases, the embodiment of a flame arrestor (100) as depicted herein will be used as part of a fuel line of a combustion motor. Specifically, it will commonly be used in the fuel tank vent. It may also be used as part of a hydraulic system. In such a system, flame from the nearby atmosphere needs to be inhibited from passing backward into the fuel tank or hydraulic system. However, one of ordinary skill in the art would recognize that these are not the only situations where a flame arrestor (100) of the type depicted herein can be useful.

There are other situations where fluid needs to pass from one area to another but flame in one of those areas needs to be inhibited from passing into the other and embodiments of the flame arrestor (100) discussed herein can be suitable for such other uses as well. This can include, but is not limited to, in a fuel line itself, in a hydraulic line, or connected between a transport line and a collection device for detecting leaks. For example, leaking hydraulic fluid could be allowed to flow through the flame arrestor (100) by dripping onto the proximal end (301) and traveling through the flame arrestor (100) to leave at the distal end (305) and be captured in a storage area.

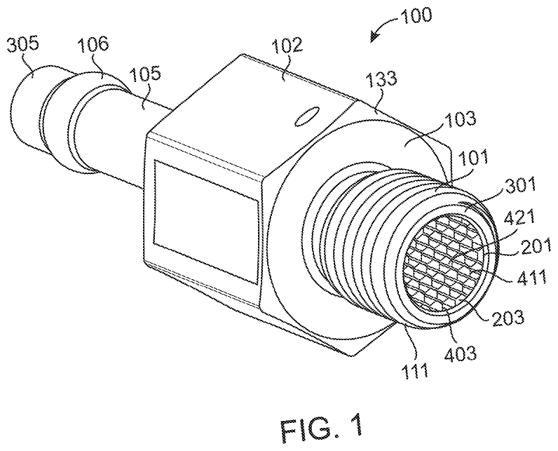

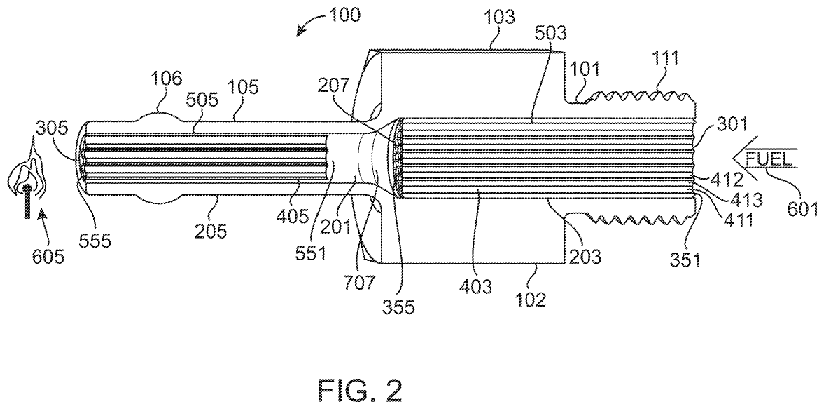

FIGS. 1 and 2 provide illustrations of an embodiment of a flame arrestor (100). The depicted flame arrestor (100) may be sized and shaped for use in a commercial aircraft as part of the fuel tank venting system such as that required by 14 CFR § 25.975(a)(7) or may be used in a hydraulic system. This size and structure is not required, but will often be used if the flame arrestor (100) is intended for use in commercial aircraft.

The flame arrestor (100) includes a main body (102) which comprises three major portions (101), (103), and (105). The main body (102) may be constructed of any suitable material which will not readily combust and is suitable for construction of such an object. This can include, but is not limited to, metals. Each of the portions (101), (103), and (105) is generally cylindrical in the depicted embodiment and, while this may be helpful for ease of manufacturing, it is by no means required. The center portion (103) may include a hexagonal sheath (133) (or may be made hexagonal) to alter its outside shape. This can be to facilitate the threads (111) being screwed into a mating connector by mating with a wrench, for example.

Toward the proximal end (301) of the main body (102) is the thread portion (101) which includes external screw threads (111) typical for attachment as part of a fuel tank vent or hydraulic system. The center portion (103) of the main body (102) is wider. This may be to provide the flame arrestor (100) with increased strength and rigidity as well as to inhibit the flame arrestor (100) thread portion (101) from being threaded onto a mating connector too far. It can also serve to provide more material to the center portion (103) of the main body (102) to deal with heat generated by a possible flame which has entered the throat (207) as contemplated later. The final section at the distal end (305) is the neck portion (105) which, as depicted, is typically narrower than the thread portion (101) or center portion (103). The neck portion (105) can be sized and shaped to allow for push connection to hydraulic lines or the like. However, the neck portion (105) need to not be narrower than the thread portion (101) or center portion (103) and may be of similar diameter or even larger than either or both the other components. The neck portion (105) will serve to support the narrow section (205) of the core (201). The neck portion (105) may also include a protrusion (106) which can serve to provide a friction connection to tubing or similar structures.

The main body (102) is hollow and has a core (201) which runs through the main body (102) from its proximal (301) to its distal (305) end and generally includes the main body's major axis, but that is not required. In the depicted embodiment, the core (201) is generally circular in cross-section and, while this will often be preferred for ease of manufacturing, it is by no means required. The core (201) also includes two major sections (203) and (205) and a throat (207) that serves to interconnect them. The first of the sections is the wide section (203) which will typically extend from the proximal end (301) of the thread portion (101) and into the center portion (103). In the depicted embodiment, the wide section (203) passes through most of the center portion (103) but this is by no means required. The wide section (203) generally terminates at the throat (207).

In the depicted embodiment, the throat (207) is generally in the form of a smooth taper from the wide section (203) to the narrow section (205). This allows the wide section (203) and narrow section (205) to be interconnected and for the core (201) to extend unbroken from the proximal end (301) to the distal end (305) of the main body (102). A smooth taper is often preferred, but is not required, and any other form of tapering or transition from the wide section (203) to the narrow section (205) may be used, including, but not limited to, a sudden step transition where the narrow section (205) immediately meets the wide section (203) or no transition at all. Regardless of the form of transition, this area interconnecting the narrow section (205) and the wide section (203) is called the throat (207) herein.

The narrow section (205), in the depicted embodiment, has a cross-sectional area which is less than the cross-sectional area of the wide section (203) and is, thus, of reduced diameter in the depicted embodiment as each section is generally cylindrical. The narrow section (205) generally extends from a point in the neck portion (105) and through the neck portion (105) until the distal end (305). In the depicted embodiment, the throat (207) is positioned toward the distal end (305) in the center portion (103) and actually extends into the neck portion (105). The wide section (203), throat (207), and narrow section (205) in combination results in the core (201) providing a hollow opening completely through the main body (102) from the proximal (301) to the distal (305) end.

Within each of the wide section (203) and the narrow section (205), there is a series of long straight channels (403) and (405), which series may be referred to as a honeycomb (503) or (505). The channels (403) form the wide honeycomb (503) and are positioned within the wide section (203). The channels (405) form the narrow honeycomb (505) and are positioned in the narrow section (205). While it is not required, each of the channels (403) and (405) in each honeycomb (503) and (505) will typically be of generally similar size and shape. Specifically, each channel (403) or (405) will comprise a hollow structure with a thin outer wall (411) generally in the shape of a hollow hexagonal cylinder with a hole (421) (which may also be hexagonal or another shape) which runs along the major axis of the channel (403) or (405).

In the depicted embodiment, the channels (403) and (405) are generally of the same cross-sectional structure with similar wall (411) thicknesses and hole (421) diameters. However, the channels (403) are slightly longer than the channels (405) in the depicted embodiment simply based on the size and shape of the relative portions (101), (103), and (105) of the main body (102). In the depicted embodiment, the holes (421) are typically small and generally are less than about 0.12 inches (as measured from adjacent flat sides of the hexagonal walls) and preferably less than 0.1 and more preferably less than 0.05 inches. Specifically, the holes (421) will typically have the minor dimension(s) be less than the quenching distance of flammable elements of the materials that will be passing through the flame arrestor (100). For example, n-hexane is a common flammable material in aircraft which may pass through the flame arrestor (100). N-hexane has a quenching distance of about .118 inches so this can be used as a preferred maximum distance between adjacent walls of the channels (403) or (405).

The channels (403) and (405) are grouped together into their respective honeycomb (503) and (505) simply by placing the various channels (403) or (405) adjacent each other. In most cases the walls (411) of adjacent channels (403) or (405) will be touching or very close and will form a structure which is essentially filled with the channels (403) or (405). The channels (403) and/or (405) may be attached to adjacent channels (403) and/or (405) in the same honeycomb (503) and/or (505) or may be held adjacent simply by friction.

The spaces (413) between the walls (411) of adjacent cylinders (403) and (405) may be left open and may form additional pathways through the honeycomb (503) or (505) or may be partially or totally filled in with solid material depending on embodiment. When hexagonal channels are used, the walls (411) are typically positioned so as to provide no or little space between them.

However, it is possible, in an embodiment, to make spaces (413) between channels (403) or (405) which enclose essentially the same hollow volume as the channel (403) or (405) without a wall of its own but by using the walls of adjacent channels (403) or (405). In such an embodiment, the spaces (413) may be filed as a means to interconnect adjacent channels (403) and/or (405) or may act as channels themselves. It should be apparent from FIG. 1 that if each channel (403) and (405) is of generally similar hole (421) diameter and wall (411) thickness, there are more total channels (403) in the wide honeycomb (503) than there are channels (405) in the narrow honeycomb (505).

As can be best seen in FIG. 2, the wide honeycomb (503) is positioned within the wide section (203) and the narrow honeycomb (505) is positioned within the narrow section (205). Each or both honeycomb (503) or (505) may extend the entire length of its respective section (203) or (205) or may stop prior to the throat (207). However, as shown in FIG. 1, the two honeycombs (503) and (505) are not in contact with each other but are spaced apart by at least the area of the throat (207) and possibly by an area which extends into one or both of the narrow section (205) or wide section (203). In the depicted embodiment, the distal end (555) of the narrow honeycomb (505) is arranged generally at the distal end (305) of the neck portion (105), and the proximal end (351) of the wide honeycomb (503) is arranged generally at the proximal end (301) of the thread portion (101). This generally coplanar positioning of the ends is, however, by no means required.

As contemplated above, the distal end (355) of the wide honeycomb (503) is spaced from the proximal end (551) of the narrow honeycomb (505). With the honeycombs (503) and (505) so spaced, there is a hollow space (707) in the core (201) around the throat (207). It should be recognized that the channels (403) and (405) may or may not be aligned on either side of the space (707). That is, some of channels (403) may be coaxial with the channels (405) but no such arrangement is required.

While the depicted embodiment of the FIGS. shows the narrow honeycomb (505) as smaller than the wide honeycomb (503) this is also not required. In an alternative embodiment, the narrow honeycomb (505) and the wide honeycomb (503) are of generally similar diameter. In a still further embodiment, the wide honeycomb (503) is actually of smaller diameter than the narrow honeycomb (505). In all of these embodiments, however, the proximal end (551) of the narrow honeycomb (505) and distal end (355) of the wide honeycomb (503) are still spaced so that a hollow space (707) is formed between them. Regardless of relative size between the honeycomb (503) and the honeycomb (505), it would be recognized that each honeycomb (503) and (505) will typically be large enough to inhibit any problematic pressure drop through the device. The space (707) will typically be smaller in volume than the volume taken by either the narrow honeycomb (505) or the wide honeycomb (503), but this is not required

Without being bound by any particular theory of operation, the spacing of the honeycombs (503) and (505) from each other to form the space (707) is intended to create areas of different fluid movement. In particular, the small cross-sectional area of the holes (421) of the channels (403) and (405) is believed to force any fluid passing therethrough to have laminar flow. However, the space (707) at the throat (207) will induce turbulence in a flow from either direction due to the fluid flowing from the more exterior channels (403) (further from the central axis of the core (201)) flowing around the surface of the throat (207) while in the space (707).

In operation, the flame arrestor (100) will generally operate as follows. The proximal end (301) will typically be attached at the fuel tank vent or at any other location that fluid is intended to flow from. Specifically, fuel vapor (or other material) (601) which needs to escape from the tank will typically flow into the core (201) of the flame arrestor (100) at the proximal end (301). The fuel vapor (601) will enter the interior holes (421) of channels (403) at the proximal end (351) of the wide honeycomb (503). Due to the small size of the holes (421), laminar flow will be induced into the fuel vapor (601) flowing through the channels (403).

The fuel vapor (601) will pass through the channels (403) out the distal end (355) of the wide honeycomb (503) and into the open space (707) at the throat (207). At this time, entry into the space (707) will induce turbulent flow into the fuel vapor (601). The turbulent fuel vapor (601) will build up some pressure in the space (707) due to the turbulence, and that pressure increase will result in the fuel vapor (601) being pushed into the holes (421) of channels (405) at the proximal end (551) of the narrow honeycomb (505). Again a laminar flow will be induced in the fuel vapor (601) and it will eventually exhaust to atmosphere at the distal end (555) of the honeycomb (505).

In the present embodiment of operation, the flame arresting capability is designed to prevent a flame (605) from traveling from the distal end (305) to the proximal end (301) while fuel vapor (601) is exhausting as contemplated above. Should a flame (605) appear at the distal end (605) it will be fed by the fuel vapor (601) which is exhausting from the distal end (305) of the flame arrestor (100). The flame (605) will attempt to deflagrate into honeycomb (505). It is expected that the flame (605) will enter the channels (405) at the distal end (555) of the narrow honeycomb (505). However, as discussed above, the flow of fuel vapor (601) through the channels (405) is generally laminar and flow of the flame through the holes (421) will also be laminar. The proximity of the walls (411) at adjacent channels (505) will act to attempt to extinguish the flame (605) due to them being closer than the quenching distance. In particular, the liberation of heat by combustion within the fluid in the channels (405) must be no more than the rate of heat loss through the wall of the narrow section (205). This can result in the flame being unable to deflagrate into the space (707) at all.

Should the flame (605) reach the space (707), the turbulent nature of the fuel vapor (601) flow in the space (707) (and any general increase in fuel in the space (707)) enables a higher rate of heat transfer. This, in turn, draws heat away from the flame quicker and lessens the ability of the flame to propagate further through the flame arrestor (100). That increased heat transfer will, thus, typically make it less likely that the flame (605) can advance as easily into the distal end (355) of the channels (403) of honeycomb (503). Even should the flame (605) advance into channels (403), their similar structure to the channels (405) will also act to extinguish the flame (605).

The inclusion of the space (707) at the throat (207) will generally act to greatly inhibit the flame's (605) ability to pass through the space (707) and throat (207). This increased inhibition can allow for the length of the main body (102) to be less than if space (707) was not included. Specifically, the combined length of the channels (403) and (405) can be decreased compared to if the throat (207) was not included and the distal end (355) was in contact with the proximal end (551). In the depicted embodiment, the various honeycombs (405) and (403) may be about 1 inch in length. This can make the flame arrestor (100) shorter and easier to fit into a smaller area. Further, decreasing the length of the honeycombs (503) and (505), along with the length of the main body (102) can decrease the flame arrestor's (100) weight which can be highly valuable when it is used in aircraft.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “parallel” are purely geometric constructs and no real-world component or relationship is truly “parallel” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A flame arrestor comprising:
a main body including a hollow core therethrough, the core having a wide section, a narrow section, and a throat interconnecting said wide section and said narrow section;
a wide honeycomb comprising a first series of hollow channels positioned in said wide section of said main body; and
a narrow honeycomb comprising a second series of hollow channels positioned in said narrow section of said main body;
wherein at least a portion of said core at said throat does not include any of said hollow channels passing therethrough.

2. The arrestor of claim 1 wherein said first series of hollow channels includes more channels than said second series of hollow channels.

3. The arrestor of claim 1 wherein a cross-sectional area of a channel in said first series of channels is generally equal to a cross-sectional area of a channel in said second series of channels.

4. The arrestor of claim 1 wherein said throat smoothly transitions said wide section into said narrow section.

5. The arrestor of claim 1 wherein said main body comprises:
a thread portion including external threads;
a center portion; and
a neck portion.

6. The arrestor of claim 5 wherein said wide section extends through said thread portion and into said center portion.

7. The arrestor of claim 5 wherein said narrow section extends through said neck portion.

8. The arrestor of claim 5 wherein said throat is at least partially within said center portion.

9. The arrestor of claim 5 wherein said throat is at least partially within said neck portion.

10. The arrestor of claim 5 wherein said thread portion has a larger cross-sectional area than said neck portion.

11. The arrestor of claim 10 wherein said center portion has a larger cross-sectional area than said thread portion.

12. The arrestor of claim 5 wherein said external threads are sized and shaped to connect to a fuel tank vent of an aircraft.

13. The arrestor of claim 5 wherein said external threads are sized and shaped to connect to a hydraulic system of an aircraft.

14. The arrestor of claim 1 wherein at least a portion of said narrow section does not include any of said hollow channels passing therethrough.

15. The arrestor of claim 1 wherein at least a portion of said wide section does not include any of said hollow channels passing therethrough.
